(19) United States
(12) Patent Application Publication
(10) Pub. No.: US 2025/0076857 A1
(43) Pub. Date: Mar. 6, 2025

(54) MOBILE APPLICATION AND USER-EXPERIENCE WITH CONTEXTUALIZED HEALTH STATISTICS FOR INDUSTRIAL AUTOMATION DEVICES

(71) Applicant: Rockwell Automation Technologies, Inc., Mayfield Heights, OH (US)

(72) Inventors: David C. Mazur, Mequon, WI (US); Marius G. Chis, Cambridge (CA); Ryan Coon, Franklin, WI (US); Scott D. Day, Richfield, WI (US); Lukasz Gornikowski, Kraków (PL); Roberto S. Marques, Mequon, WI (US); Jonathan A. Mills, Mayfield Heights, OH (US); Nathaniel S. Sandler, Cleveland, OH (US); Kurt D. Sneen, Park City, UT (US); Patryk Woszczyna, Krakow (PL)

(73) Assignee: Rockwell Automation Technologies, Inc., Mayfield Heights, OH (US)

(21) Appl. No.: 18/460,234

(22) Filed: Sep. 1, 2023

(51) Int. Cl. G05B 19/418

(52) U.S. Cl. CPC G05B 19/4183; G05B 19/4184; G05B 2219/37088

(57) ABSTRACT

The present technology relates to health metrics corresponding to industrial automation devices and a user experience for viewing and configuring health metrics. Health metrics of a device can be produced by obtaining performance metrics of the device and contextualizing the performance metrics based on contextualization information. The health metrics can be categorized based on applying rule sets to the health metrics. The rule sets can be selectively applied to the health metrics based on a type of a respective health metric. The health metrics and health metric categories can be instantiated in a user interface of a user device based on a request for device health information from the user device.

### RELATED APPLICATIONS

This application is related to co-pending U.S. Patent Application, Attorney Docket No. 2023P-105-US, titled “EDGE DEVICE SUPPORT OF COMPUTATION OF CONTEXTUALIZED HEALTH STATISTICS IN AN INDUSTRIAL AUTOMATION ENVIRONMENT,” filed concurrently, and co-pending U.S. Patent Application, Attorney Docket No. 2023P-106-US, titled “HUMAN INTERFACE MODULE (HIM) CONNECTIVITY AND INTERFACE FOR CONTEXTUALIZED HEALTH STATISTICS IN AN INDUSTRIAL AUTOMATION ENVIRONMENT,” filed concurrently, the contents of which are incorporated by reference in their entireties for all purposes.

### TECHNICAL FIELD

Various embodiments of the present technology relate to industrial automation devices and particularly to health statistics associated with industrial automation devices.

### BACKGROUND

Industrial automation environments, such as factories, mills, and the like, employ various devices like sensors and actuators (e.g., drives), machinery, and other components to perform industrial processes. Controllers and processors can automate various industrial systems and associated processes. For example, a controller connected to an industrial system can direct devices to perform functions in an integrated manner that, together, produces results. It is important to ensure that each device in the industrial system is working properly otherwise the industrial system as a whole may be at risk of failure.

Various solutions exist today to monitor industrial system performance and device performance. For example, sensors can be used to track outputs of devices in an industrial system. By way of another example, controllers connected to an industrial system may obtain data output by devices in the industrial system. Such solutions can generate copious amounts of data to perform trend analyses and monitor systems, among other features. However, the data generated by these solutions is not always helpful to end-users. Often times, such data is confined to what the vendor of the solution defines or to limitations of the sensors and actuators of a system. It may be cumbersome or even impossible to re-define or re-program sensors, actuators, or existing monitoring solutions. Thus, these solutions can fail to use raw data originating from an industrial system or devices to generate insights into the data based on end-user requirements at run-time of an industrial system.

### SUMMARY

Systems, devices, and methods are provided herein for producing health metrics associated with industrial automation devices and instantiating the health metrics on a user interface to visualize health information about the industrial automation devices. An industrial or commercial environment may include various industrial automation devices, such as variable-speed drives, motors, belts, and the like, that perform industrial automation processes. More particularly, a variable-speed drive may be coupled to various other devices and control an industrial automation process via the other devices. A variable-speed drive may receive signals from connected devices indicative of performance of the devices (also referred to as performance metrics). Such performance metrics can be contextualized and used with rule sets to analyze the health of the variable-speed drive and connected devices. The health information related to the devices can be provided to a user interface navigable by a user for the user to view performance, health, and conditions of the devices.

In an embodiment of the present technology, a system for producing a user interface with health information associated with industrial automation devices is provided. The system includes one or more computer-readable storage media, one or more processors coupled to the one or more computer-readable storage media, and program instructions stored on the one or more computer-readable storage media that, based on being read and executed by the one or more processors, direct the system to perform various functions. For example, the program instructions may direct the system to obtain a plurality of performance metrics associated with devices in an industrial automation environment. The program instructions may also direct the system to contextualize each of the performance metrics based on contextualization information specific to each of the performance metrics to produce device health metrics and classify each of the device health metrics into device health metric categories based on applying a rule set to each of the device health metrics. The system can then provide a device health metric and a device health metric category associated with a selected device to a user interface of a user device based on a request from the user device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

While multiple embodiments are disclosed, still other embodiments of the present technology will become apparent to those skilled in the art from the following detailed description, which shows and describes illustrative embodiments of the invention. As will be realized, the technology is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example operating environment in accordance with some embodiments of the present technology.

FIG. 2 illustrates an example block diagram of a memory and a server capable of producing device health metrics in accordance with some embodiments of the present technology.

FIG. 3 illustrates an example series of operations performable on a performance metric output from an industrial device in accordance with some embodiments of the present technology.

FIG. 4 illustrates a series of steps for providing a user interface with device health metrics of industrial devices in accordance with some embodiments of the present technology.

FIGS. 5A, 5B, 5C, 5D, 5E, 5F, and 5G illustrate example representations of user interfaces including device health metrics of industrial automation devices in accordance with some embodiments of the present technology.

FIG. 6 illustrates an example computing system used in some embodiments of the present technology.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Various embodiments of the present technology relate to health metrics corresponding to devices in an industrial automation environment, and more particularly, to a user experience for configuring, customizing, requesting, and viewing the health metrics. In industrial and commercial environments, various devices, such as drives, motors, relays, sensors, and the like along with the driven machinery, such as conveyors, pumps, fans, and more, which can be used to perform industrial, manufacturing, and commercial processes. Several processes involving such devices can be automated through the use of processors and controllers coupled to devices. However, data gathered from the devices during run-time operations of industrial processes is often unhelpful and limited. For example, controllers coupled to devices may have limited interfaces that only show a few metrics or signals coming from a connected device. The signals obtained from these controllers may only indicate performance data at a given time on such interfaces. In conventional solutions, vast amounts of data are often gathered and run through complex software to understand if the way in which the devices are being operated is appropriate or sustainable without issues. However, customization and contextualization of data based on end-user needs is not offered or requires re-programming from software engineers trained on the solutions.

To address these issues, a system can gather performance metrics from various industrial devices, analyze the health and condition of the devices, and predict unhealthy behavior based on the performance metrics. Further, the system can provide indications of the health, condition, and performance on navigable dashboards of a user interface for a user to view information about the devices and take actionable measures to alleviate current risks or prevent future risks in the industrial environment. The outputs of the system can be generated based on end-user configurations and customizations through a user experience that also displays the outputs.

In an embodiment of the present technology, a system for producing a user interface with health information associated with industrial automation devices is provided. The system includes one or more computer-readable storage media, one or more processors coupled to the one or more computer-readable storage media, and program instructions stored on the one or more computer-readable storage media that, based on being read and executed by the one or more processors, direct the system to perform various functions. For example, the program instructions may direct the system to obtain performance metrics associated with devices in an industrial automation environment. The program instructions may also direct the system to contextualize each of the performance metrics based on contextualization information specific to each of the performance metrics to produce device health metrics. The system can classify each of the device health metrics into device health metric categories based on applying a rule set to each of the device health metrics. The system can then provide a device health metric and a device health metric category associated with a selected device to a user interface of a user device based on a request from the user device.

In another embodiment, a method of instantiating a user interface with device health metrics is provided. The method includes obtaining a performance metric associated with a device in an industrial automation environment. The performance metric can be contextualized based on contextualization information specific to the performance metric to produce a device health metric. The device health metric can be categorized based on applying a rule set to the device health metric. The rule set is selected based on a type of the device health metric. Following a request from a user device, the device health metric and the device health metric category can be provided to a user interface of the user device.

In yet another embodiment, a system for providing a user interface to a user device with health information associated with industrial automation devices is provided. The system includes one or more computer-readable storage media, one or more processors coupled to the one or more computer-readable storage media, and program instructions stored on the one or more computer-readable storage media that, based on being read and executed by the one or more processors, direct the system to perform various functions. For example, the program instructions may direct the system to provide a user interface to the user device. The user interface may include a navigable dashboard with indications corresponding to industrial automation devices. The indications may include device health indications, behavioral indications, and maintenance indications. The device health indications indicate the health of the industrial automation devices based on contextualized metrics associated with the devices. The behavioral indications indicate the behavior of the industrial automation devices based on applying rule sets to the contextualized metrics. The maintenance indications indicate maintenance tasks corresponding to the industrial automation devices.

Advantageously, the disclosed system can produce device health information from raw data obtained from industrial devices and provide a user experience with visualizations of the device health information, such as predictive and preventative maintenance tasks, threshold-related comparisons, and other risks posed by run-time performance of the industrial devices, which can provide meaningful insight to users in a user interface of a user device. Not only may this equip a user with insightful metrics related to performance and health of an industrial device, but also this may reduce overhead for purchasing and operating complex software programs pre-configured to analyze specific measurements and risks associated with an industrial automation system. Accordingly, reducing the use and need for complex software programs may reduce processing and memory requirements for computing systems. Additionally, such a user experience can also allow a user to re-define or configure customized device health information as necessary without requiring the expertise of a software engineer. This can further reduce processing and memory requirements as operations and logic for performing device health processes can be simplified and distributed to one or more processing systems available in an industrial automation environment, such as devices themselves, controllers of the devices, and one or more different servers.

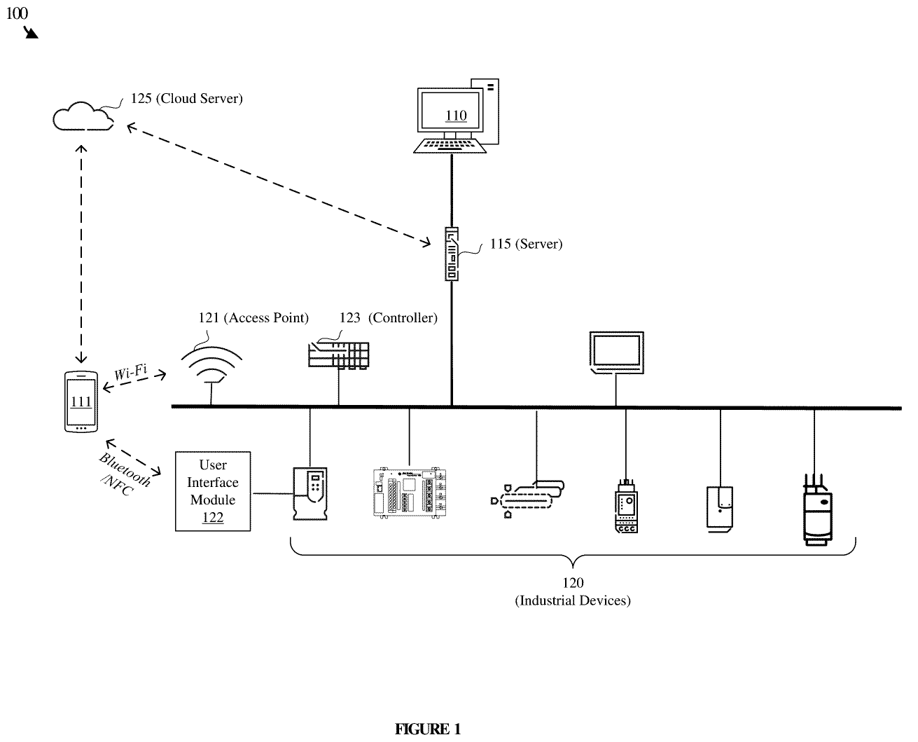

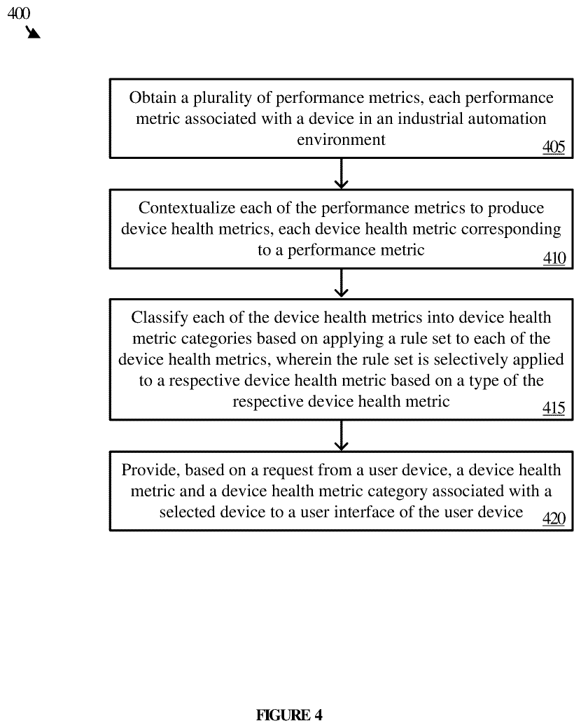

Turning now to the Figures, FIG. 1 illustrates an example operating environment 100 demonstrating industrial, commercial, and automation elements. Operating environment 100 includes user device 110, user device 111, server 115, industrial devices 120, access point 121, and cloud server 125. In various examples, server 115 may be configured to perform device health processes, such as process 400 of FIG. 4, and provide device health metrics to a user interface of a user device, such as user devices 110 and 111.

Operating environment 100 is representative of an environment in which industrial and commercial processes can occur, and in which a user may operate a user device (e.g., user device 110, user device 111) to view device health information (i.e., metrics, statistics, parameters, and characteristics related to health, performance, and condition) of industrial devices 120 used in performing industrial and commercial processes.

User device 110 is an example of a computing device operable in operating environment 100. User device 110 may include a screen and one or more peripheral devices to operate user device 110. User device 110 can display an instance of a device health application on the screen, which may include one or more dashboards having status indicators, behavior indicators, preventative or predictive maintenance indicators, and the like, related to industrial devices 120. User device 110 may download and run the device health application, or user device 110 may surface the device health application via a web-based browser. The one or more peripherals, such as a mouse, for example, can be used to navigate and interact with the device health application on a user interface displayed on the screen of user device 110. For example, a user can navigate the device health application to view various device health metrics related to industrial devices 120. Furthermore, the user can use the device health application to configure device health metrics to customize the device health metrics as needed based on the operation of industrial devices 120. Operating environment 100 may include any number of user devices 110.

Server 115 is an example of one or more servers, processors, or other computing devices operating in operating environment 100. In some examples, server 115 may be an edge server located on the premises of an industrial automation environment. In other examples, server 115 may be located remotely from the industrial automation environment (i.e., a cloud-based server). Server 115 may include hardware, software, and firmware, or any combination or variation thereof, to perform device health processes. Server 115 may obtain data from industrial devices 120, controller 123, or one or more of human interface module 122 coupled to industrial devices 120 via a wired connection at an industrial facility or via a wireless connection such as by using a communication network. Server 115 may further communicate with cloud server 125 via a wired or wireless communication network.

Industrial devices 120 include various types of industrial and commercial devices that may be used to perform respective processes in operating environment 100. For example, industrial devices 120 may include one or more of variable-speed drives, motors, circuit devices, relays, sensors, and more. Various components of industrial devices 120 may be coupled together via wired or wireless connections, such as through access point 121. As industrial devices 120 perform respective processes, industrial devices 120 can produce signals and measurements indicative of performance. A variable-speed drive may produce various signals from a motor connected to it. By way of example, the variable-speed drive may provide signals indicative of motor voltage, motor temperature, motor speed, or the rate of change of internal temperature of one or more power electronic components, among other signals. Such signals can be obtained by server 115 or user device 111.

In other examples, controller 123, coupled to one or more of industrial devices 120, may obtain the signals and measurements indicative of performance of industrial devices 120 and provide the signals and measurements to other components. Controller 123 is representative of a controller or control module, such as a PLC or an analytic option card, associated with a device in operating environment 100. In some examples, controller 123 may be externally coupled with one or more of industrial devices 120 and can control functionality of the devices. In other examples, controller 123 may be installed in one or more of industrial devices 120 and can provide device health analytics control and monitoring.

User interface module 122 may be representative of a user interface device that can be coupled to one or more of industrial devices 120 to display information about the performance and health of industrial devices 120. User interface module 122 may be associated with a single device. User interface module 122 may, however, be associated with multiple devices. Regardless, controller 123 and/or user interface module 122 may control operations of respective industrial devices 120 and provide data to server 115 or user device 111 based on the performance of the respective industrial devices 120.

Access point 121 is representative of a wireless network connection point for connecting one or more devices to a communication network in the industrial automation environment. In various examples, one or more of industrial devices 120 may be connected to access point 121. Server 115 may also be connected to the same communication network that access point 121 provides access to. Thus, server 115 may obtain data associated with industrial devices 120 via a communication network accessible through access point 121.

Access point 121 can also provide a wireless connection point for user device 111 to connect to the communication network and to obtain data from industrial devices 120 or server 115. User device 111 is representative of a handheld mobile device, such as a smart phone or tablet, which can connect to devices in operating environment 100 via wireless connections. For example, user device 111 can connect to access point 121 via a Wi-Fi connection. User device 111 may, alternatively or additionally, connect to industrial devices 120 via user interface module 122 of industrial devices 120. In various examples, user device 111 can connect to user interface module 122 via a Bluetooth connection or via a near field communication (NFC) protocol. In such examples, user device 111 may be located in close proximity to user interface module 122, industrial devices 120, and access point 121 to interface with such components.

User device 111 may also be connected to cloud server 125 via the same communication network provided by access point 121 or a different communication network. Cloud server 125 is representative of a cloud-based environment in which at least some other operations for device health processes may be performed. In various examples, cloud server 125 may include one or more servers, processors, databases, datacenters, and the like capable of receiving performance metrics and device health metrics from server 115 or user device 111. Cloud server 125 may obtain data from server 115 and user device 111, perform device health processes on the data, and provide device health metrics, or indications of the device health metrics, to server 115 and user device 111 for instantiation on a user interface of user devices 110 and 111.

Like user device 110, user device 111 may also include a user interface for displaying an instance of a device health application. User device 111 may download the device health application from an application store or access the instance of the device health application from a browser. The instance displayed on user device 111 may include one or more navigable dashboards having status indicators, behavior indicators, preventative or predictive maintenance indicators, and the like, related to industrial devices 120. Similarly, a user of user device 111 could navigate the device health application displayed on user device 111 to view, configure, and customize device health metrics associated with industrial devices 120. In some examples, the instance of the device health application operable on user device 111 may differ from the instance of the device health application operable on user device 110. For example, dashboards available for navigation on user device 110 may differ in size and information relative to dashboards available for navigation on user device 111. Regardless, the indications and information displayed on user device 110 may be obtained from server 115, cloud server 125, controller 123, user interface module 122 of industrial devices 120, or industrial devices 120 via a communication network.

In operation, a user may request device health metrics associated with one or more industrial devices 120 via user device 110 or user device 111. From user device 110, the request can be provided to server 115. Server 115 can identify the request and the respective industrial device based on the request. Server 115 can obtain performance metrics from the industrial device, from controller 123, or from user interface module 122 of the industrial device. Then, server 115 can perform operations on the performance metrics to contextualize the performance metrics based on contextualization information specific to the performance metrics and produce device health metrics. Contextualization information may include information indicative of a type of value (e.g., voltage, temperature, current) of the performance metrics. By way of example, for a request seeking information about health of a motor in the industrial automation environment, a performance metric related to motor speed may be obtained. Contextualization of the motor speed may include identifying the type of performance metric and the unit of measurement of the performance metric (e.g., rotations per minute (RPM)) and converting the value of the performance metric to a percentage. Thus, the contextualized performance metric, or device health metric, may indicate at what percentage of capable motor speed the motor is running (e.g., 85%).

Server 115 may also apply one or more rule sets to the device health metrics to produce device health metrics categories, including a healthy category, an unhealthy category, and an approaching unhealthy category, among other categories. The rule sets may include threshold values, time windows or time ranges, or other defined rules. Following the previous example using percentage of motor speed, the request may seek information corresponding to the health of the device when operating with such performance. A first rule set can be applied to determine the duration that the motor has been running at the motor speed. A second rule set can further be applied to determine whether the motor has been running beyond a threshold value for a threshold duration. As a result of applying the rule sets, server 115 can determine whether the motor is operating in a healthy state, an unhealthy state, or an approaching unhealthy state. Server 115 can provide both the device health metrics and the device health metrics categories to user device 110 for instantiation on the user interface of user device 110.

From user device 111, the request for device health metrics can be provided to cloud server 125, server 115 (via access point 121), or industrial devices 120 (either directly or via controller 123 or user interface module 122). Cloud server 125 and industrial devices 120 may provide the request to server 115 to perform operations on the performance metrics as described above. However, in some cases, cloud server 125 or industrial devices 120 may perform at least a subset of the operations on the performance metrics instead of or in addition to providing the request to server 115 to perform operations on the performance metrics. In either case, the contextualization and rule sets may be performed on the performance metrics to produce device health metrics and device health metrics categories, respectively, based on the request. Server 115 or cloud server 125 can then provide the device health metrics and device health metric categories to the user interface of user device 111.

In various examples, cloud server 125 and server 115 may store performance metrics gathered from industrial devices 120 based on requests in one or more databases. Thus, previously stored performance metrics can be used to provide historical health metrics, trend analysis, predictive maintenance metrics, and the like to user devices 110 or 111 based on requests.

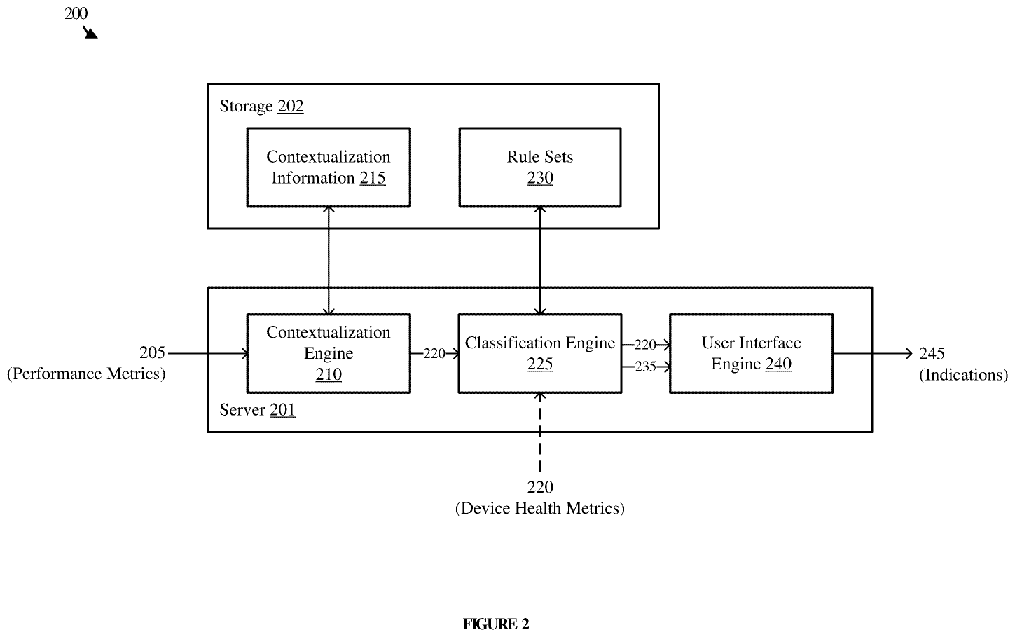

FIG. 2 illustrates an example block diagram 200 including a server 201 and a storage 202 capable of producing device health information in accordance with some embodiments of the present technology. Server 201 includes contextualization engine 210, classification engine 225, and user interface engine 240. Storage 202 includes contextualization information 215 and rule sets 230. In various examples, server 201 and associated components may represent server 115 of FIG. 1.

Server 201 is representative of one or more servers, processors, or other computing devices capable of performing device health processes on performance metrics 205 and producing indications 245 for visualization on a user interface of a user device. In some examples, server 201 may be an edge server that is located on the premises of an industrial or commercial environment. Alternatively, server 201 may be located remotely from an industrial environment. Server 201 may include hardware, software, and firmware components, or any combination or variation thereof, to perform such operations. Examples of such components may include contextualization engine 210, classification engine 225, and user interface engine 240.

Performance metrics 205 are provided to server 201 from one or more industrial devices operating in an industrial automation environment (e.g., operating environment 100 of FIG. 1). Performance metrics 205 may include signals and measurements indicative of performance of the industrial devices. For example, performance metrics 205 may include voltage measurements, motor speed, device temperature, and the like of one or more industrial devices. Contextualization engine 210 of server 201 can receive performance metrics 205 either directly from the industrial devices, from a controller (e.g., PLC, installed option card), or from a user interface module associated with the industrial devices (e.g., a human interface module (HIM). In some examples, contextualization engine 210 may alternatively obtain performance metrics 205 from a database that stores performance metrics 205.

Contextualization engine 210 is representative of any processor or processing unit capable of contextualizing performance metrics 205 from industrial devices in an industrial automation environment and producing device health metrics 220. Examples of such processor(s) may include microcontrollers, DSPs, general purpose central processing units, application specific processors or circuits (e.g., ASICs), and logic devices (e.g., FPGAs), as well as any other type of processing device, combinations, or variations thereof.

Contextualization of performance metrics 205 refers to providing context to performance metrics 205 to make performance metrics 205 more useful and insightful to a user reading performance metrics 205. For example, contextualizing performance metrics may include re-formatting performance metrics 205 to a different type of data or adding additional data or indications to performance metrics 205. In various examples, contextualizing performance metrics 205 includes performing one or more operations on performance metrics 205 using contextualization information 215 from storage 202. Such operations may include re-formatting operations, mathematical operations, and filtering operations.

Storage 202 is representative of one or more databases capable of being read from and written to by server 201 and associated components. Storage 202 may include volatile and nonvolatile, removable and non-removable media elements implemented in any method of technology for storage of information, such as contextualization information 215 and rule sets 230. Storage 202 is shown as a single component but may be implemented as one or more storage devices and may include devices for storing software and firmware. As such, storage 202 may be implemented separately or in an integrated manner with respect to other types of storage. Storage 202 is not a transitory signal in any embodiment.

Contextualization information 215 includes information for the contextualization of performance metrics 205 specific to a type of performance metric. For example, contextualization information 215 may include information indicative of a type of a value (e.g., voltage, temperature, current, speed) or unit of measurement of a value (e.g., volts, degrees Fahrenheit, amps, RPM). By way of example, performance metrics 205 may be related to motor speed. Contextualization information 215 may include information indicating that performance metrics 205 includes a speed and a unit of measurement of the speed. Contextualization engine 210 can use performance metrics 205 and contextualization information 215 to contextualize performance metrics 205, such as by performing an operation to convert the value of performance metrics 205 from RPM to a percentage of total capable motor speed (e.g., 85%). The contextualized performance metric may be referred to as device health metrics 220, which can be provided to classification engine 225.

Device health metrics 220, or a subset of device health metrics 220, may instead or additionally be obtained from a different source than contextualization engine 210. For example, device health metrics 220 may be determined and provided by a user device, a cloud-based server, the industrial device, a controller associated with the industrial device, a user interface device associated with the industrial device, or a combination or variation thereof, such as components other than server 115 in operating environment 100 of FIG. 1.

Classification engine 225 is also representative of any processor or processing unit. In various examples, classification engine 225 and contextualization engine 210 may be embodied in a single processor. However, in other examples, classification engine 225 and contextualization engine 210 may operate independently with respect to one another. Classification engine 225 receives device health metrics 220 from contextualization engine 210 and obtains rule sets 230 from storage 202. Classification engine 225 can apply rule sets 230 to device health metrics 220 to produce device health metrics categories 235 indicative of a health and condition of the industrial device.

Rule sets 230 may include threshold values, time windows or time ranges, or other defined rules specific to device health metrics 220. In some cases, rule sets 230 may be user-defined, pre-configured rules and threshold values based on the industrial device and performance metrics 205 obtainable from the industrial device, among other factors. Following the previous example using percentage of motor speed, a user may seek information corresponding to the health of the industrial device (e.g., motor) when operating under such conditions. A first rule set can be applied to determine the duration that the motor has been running at the motor speed. A second rule set can also be applied to determine whether the motor has been running beyond a threshold value for a threshold duration. As a result of applying rule sets 230, classification engine 225 can determine whether the motor is operating in a healthy state, an unhealthy state, or an approaching unhealthy state. Accordingly, device health metrics categories 235 may indicate a health status, such as healthy, unhealthy, or approaching unhealthy. However, other status indicators may be contemplated. Classification engine 225 can provide device health metrics categories 235 to user interface engine 240.

User interface engine 240 is also representative of any processor or processing unit. User interface engine 240 may function as an independent processor with respect to contextualization engine 210 and classification engine 225, but in some examples, user interface engine 240 may also function in an integrated manner with respect to contextualization engine 210 and classification engine 225. User interface 240 can obtain device health metrics 220 and device health metrics categories 235 from classification engine 225 and produce indications 245 from device health metrics 220 and device health metrics categories 235.

Indications 245 include representations of the data of device health metrics 220 and device health metrics categories 235 for display on a user interface of a user device. For example, indications 245 may include color indicators, such as green, yellow, and red, based on device health metrics categories, such as healthy, approaching unhealthy, and unhealthy, respectively. Indications 245 may also include values, units of measurement, and names corresponding to device health metrics 220 and device health metrics categories 235 for display on the user interface. User interface engine 240 can provide indications 245 to a user device (e.g., a computing device, a smart phone, a tablet), such as user devices 110 or 111 of FIG. 1.

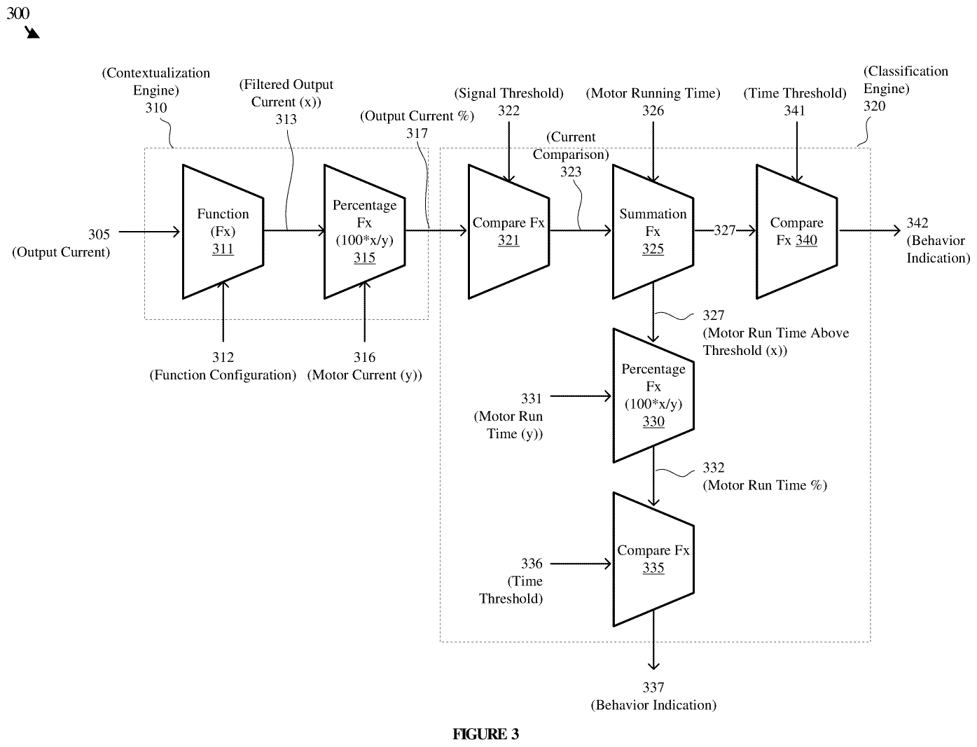

FIG. 3 illustrates an example series of operations performable on a performance metric output from an industrial device in accordance with some embodiments of the present technology. FIG. 3 shows block diagram 300, which further includes contextualization engine 310 and classification engine 320 and functions performable by contextualization engine 310 and classification engine 320. For example, functions shown and described below with respect to contextualization engine 310 and classification engine 320 may be applicable to contextualization engine 210 and classification engine 225, respectively, of block diagram 200 of FIG. 2.

Contextualization engine 310 is representative of any processor or processing unit capable of contextualizing performance metrics from industrial devices in an industrial automation environment and producing device health metrics for use in a user interface. Examples of such processor(s) may include microcontrollers, DSPs, general purpose central processing units, application specific processors or circuits (e.g., ASICs), and logic devices (e.g., FPGAs), as well as any other type of processing device, combinations, or variations thereof.

Contextualization of performance metrics refers to providing context to a signal or value output by an industrial device (e.g., output current 305) to make the output more useful and insightful to a user reading the performance metrics. For example, contextualizing performance metrics may include re-formatting a performance metric to a different type of data or adding additional data or indications to the performance metric. In the example illustrated in block diagram 300, contextualization engine 310 may contextualize output current 305 from an industrial device. Output current 305 may be a current output by an industrial device while performing run-time operations in an industrial environment. Contextualizing output current 305 may include performing one or more operations on output current 305 using contextualization information, such as function configuration 312 and motor nominal current 316. Such operations may include re-formatting operations, mathematical operations, and filtering operations.

Output current 305 can be fed to function 311 of contextualization engine 310. Function 311 is representative of a first operation performable by contextualization engine 310. Function 311 can also be fed function configuration 312, which may control how function 311 performs operations on output current 305. In this example, function 311 may include a filtering operation. Accordingly, function configuration 312 may identify a time range to filter out from output current 305 or threshold current values to remove from output current 305. Performing function 311 may further entail applying a moving average filter or a low-pass filter to generate filtered output current 313 representative of a stable output signal of output current 305. Function 311 can output filtered output current 313 as an input to percentage function 315 as a result of filtering operations.

Percentage function 315 is representative of a second operation performable by contextualization engine 310. Percentage function 315 can also be fed motor current 316, which may identify a nominal or rated current of the industrial device (e.g., a motor). Percentage function 315 can perform an operation using filtered output current 313 and motor nominal current 316 to produce output nominal current percentage 317. For example, percentage function 315 can use the following operation to convert the current value into a percentage value:

$$Output current percentage 317 = 100 * ( filtered output current 313 / motor nominal current 316 ) .$$

Percentage function 315 can output nominal current percentage 317 to compare function 321 of classification engine 320. In various examples, nominal current percentage 317 is referred to as a contextualized performance metric or a device health metric.

Classification engine 320 is also representative of any processor or processing unit. In various examples, classification engine 320 and contextualization engine 310 may be embodied in a single processor. However, in other examples, classification engine 320 and contextualization engine 310 may operate independently with respect to one another. Classification engine 320 receives device health metrics, such as output nominal current percentage 317, and obtains rule sets to apply rules and threshold values to the device health metrics and output device health metrics categories. To do so, classification engine 320 can include various functions capable of applying the rule sets to device health metrics input to classification engine 320. The rule sets may include threshold values, time windows or time ranges, or other defined rules specific to the device health metrics. As illustrated in block diagram 300, signal threshold 322 and time thresholds 336 and 341 are examples of rule sets. In some cases, the rule sets may be user-defined, pre-configured rules and threshold values based on the industrial device and performance metrics obtainable from the industrial device, among other factors.

Compare function 321 is representative of a first operation performable by classification engine 320. Compare function 321 can intake output current percentage 317 from contextualization engine 310 and signal threshold 322 and perform a compare operation using the input values. Signal threshold 322 may include a threshold value related to the current of the industrial device. For example, signal threshold 322 may indicate a maximum output current percentage. Compare function 321 can then perform a comparison between output nominal current percentage 317 and signal threshold 322 to produce current comparison 323.

Summation function 325 is representative of a second operation performable by classification engine 320. Summation function 325 can receive current comparison 323 and motor running time 326 as inputs. Motor running time 326 may include a performance metric corresponding to the industrial device indicative of the duration that the industrial device has been operating. Motor running time 326 may also include a threshold value related to the maximum run-time of the industrial device. Accordingly, summation function 325 can perform a summing operation to determine motor run time above threshold 327, which may indicate whether the industrial device has been operating within or beyond the threshold motor running time 326. Summation function 325 can provide motor run time above threshold 327 to compare function 340 and percentage function 330.

Percentage function 330 is representative of a third operation performable by classification engine 320. Percentage function 330 may receive motor run time 331 from the industrial device, or another source, and perform an operation using motor run time 331 and motor run time above threshold 327 to produce motor run time percentage 332. Motor run time 331 may include a duration of time that the industrial device has been operating. Percentage function 330 can use the following operation to convert the run time values from a unit of measurement related to time into a percentage value:

$$Motor run time percentage 332 = 100 \times \frac{Motor run time above threshold 327}{Motor run time 331}$$

Percentage function 330 can output motor run time above threshold percentage 332 to compare function 335.

Compare function 335 is representative of a fourth operation performable by classification engine 320. Compare function 335 can intake motor run time above threshold percentage 332 and time threshold 336 and perform a compare operation using the input values. Time threshold 336 may include a threshold time or duration that the industrial device can exceed a threshold motor speed before the industrial device is at risk of failure, for example. The comparison performed by compare function 335 can result in behavior indication 337, which may indicate whether the industrial device is performing in a healthy state, an unhealthy state, or in an approaching unhealthy state. Classification engine 320 can provide behavior indication 337 to a user interface engine (e.g., user interface engine 240 of FIG. 2) for instantiation on a user interface of a user device.

Compare function 340 is representative of a fifth operation performable by classification engine 320. Compare function 340 can intake motor run time above threshold 327 and time threshold 341 and perform a compare operation using the input values. Time threshold 341 may include a threshold time or duration that the industrial device can operate for before the industrial device is at risk of failure, for example. The comparison performed by compare function 340 can result in behavior indication 342, which may indicate whether the industrial device is performing in a healthy state, an unhealthy state, or in an approaching unhealthy state. Classification engine 320 can also provide behavior indication 342 to a user interface engine for instantiation on a user interface of a user device.

Contextualization engine 310 and classification engine 320 may include various other functions and operations not shown in block diagram 300. The selection of functions and operations performed by contextualization engine 310 and classification engine 320 may be based on a request for device health metrics and behavior indications from a user. For example, a request seeking information about temperature of an industrial device may result in a different combination or variation of functions and operations by contextualization engine 310 and classification engine 320. Accordingly, various functions and operations can be retrieved from storage and used interchangeably, on-the-fly, as requests for device health information are made. By way of another example, function 311 may be replaced with a maximum function that may capture peak current during a time frame. Multiple filters, moving average functions, or the like may be used separately or in combination with one another.

FIG. 4 illustrates a series of steps for providing a user interface with device health metrics of industrial devices in accordance with some embodiments of the present technology. FIG. 4 includes process 400, each operation noted parenthetically in the discussion below and which reference elements of FIG. 1. It may be appreciated that process 400 can be implemented on software, firmware, hardware, or any combination or variation thereof. For example, process 400 can be executed on or by a server in an industrial automation environment, such as server 115 of FIG. 1 or server 201 of FIG. 2.

In operation 405, server 115 obtains (405) performance metrics from industrial devices 120 operating in an industrial automation environment. Each of the performance metrics may be associated with a particular device of industrial devices 120. For example, the performance metrics may include temperatures, output voltages, output currents, motor speeds, torque, and the like, each associated with one or more industrial devices 120. It follows that the performance metrics may indicate a performance of industrial devices 120, such as “off,” “on,” and varying levels of performance while “on.” In some examples, server 115 may obtain the performance metrics directly from industrial devices 120. In other examples, server 115 may obtain the performance metrics from one or more controllers associated with industrial devices 120 (e.g., controller 123) or one or more user interface modules associated with industrial devices 120 (e.g., user interface module 122). Regardless, server 115 may obtain the performance metrics during run-time or following use of industrial devices 120 in an industrial process. Further, server 115 may obtain the performance metrics based on a request from a user device (e.g., user device 110 or 111), or server 115 may continuously gather the performance metrics.

In operation 410, server 115 contextualizes (410) each of the performance metrics to produce device health metrics. Contextualizing the performance metrics may include performing one or more operations on the performance metrics based on contextualization information specific to the performance metrics. Contextualization information may include information indicative of a type of value (e.g., voltage, temperature, current) of the performance metrics and a unit of measurement of the value, for instance. By way of example, a performance metric related to motor speed may be obtained. Contextualization of the motor speed may include identifying the type of performance metric (e.g., motor speed), identifying the unit of measurement of the performance metric (e.g., rotations per minute (RPM)), and converting the value of the performance metric to a percentage. Thus, the contextualized performance metric, or device health metric, may indicate at what percentage of capable motor speed the motor is running (e.g., 85%) relative to the motor speed capacity of the industrial device.

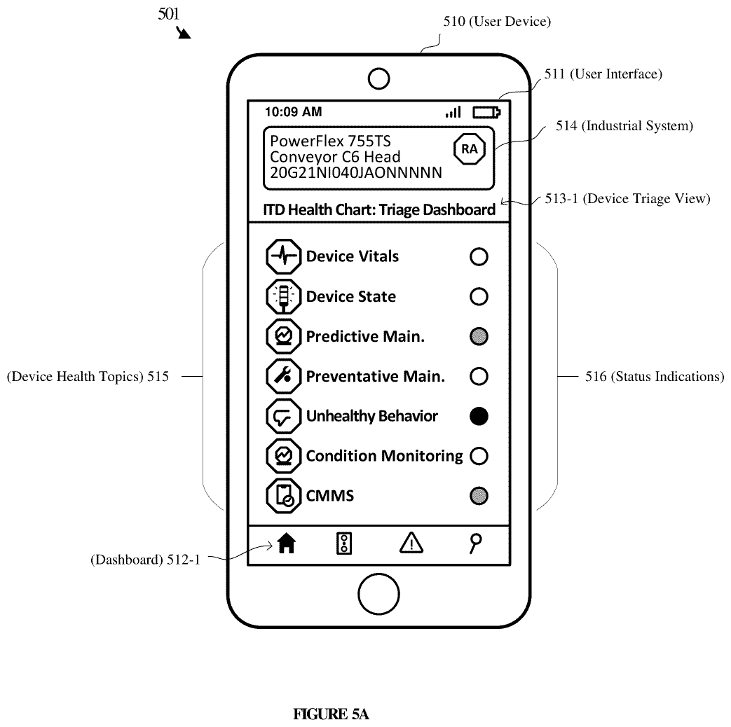

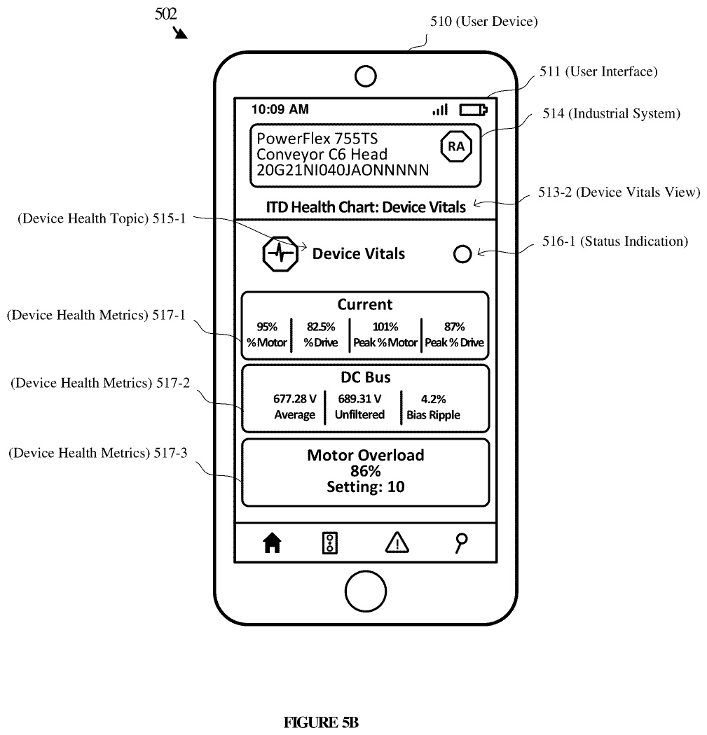

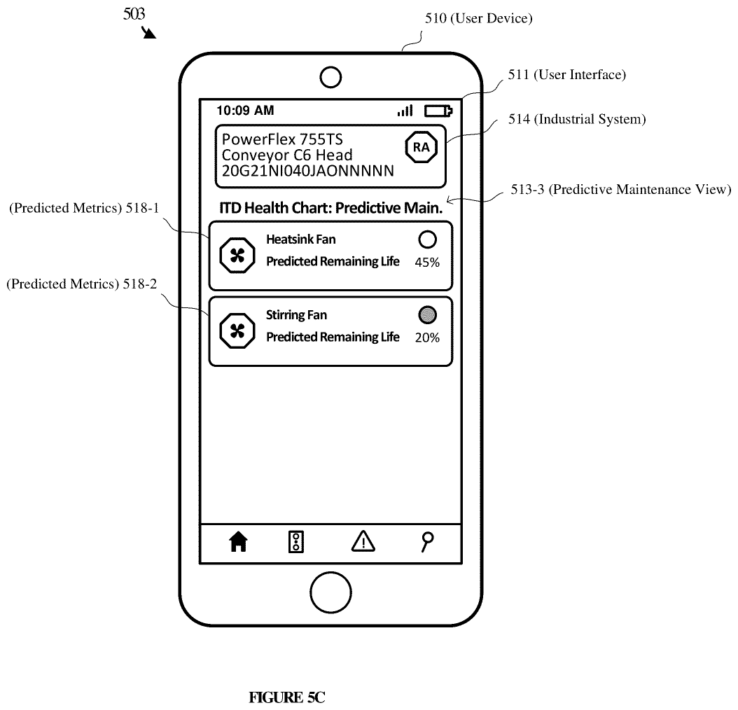

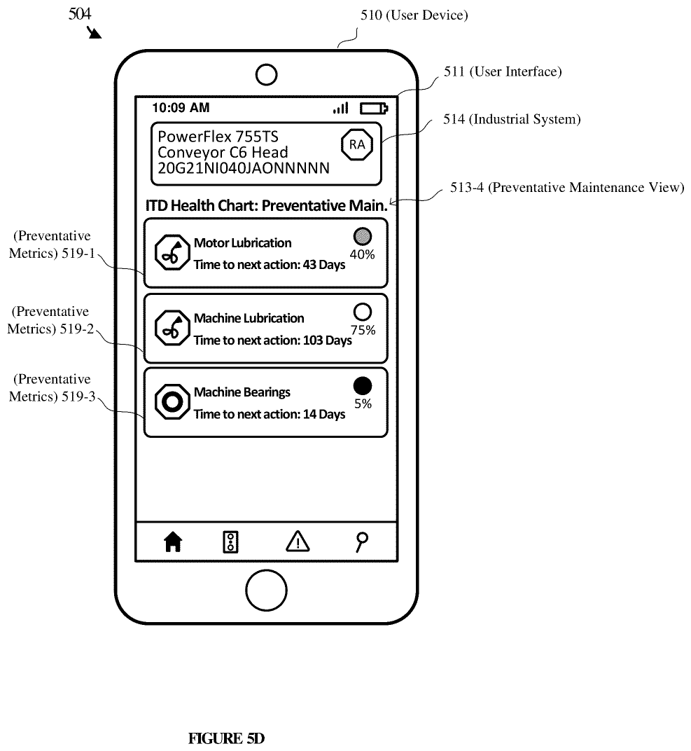

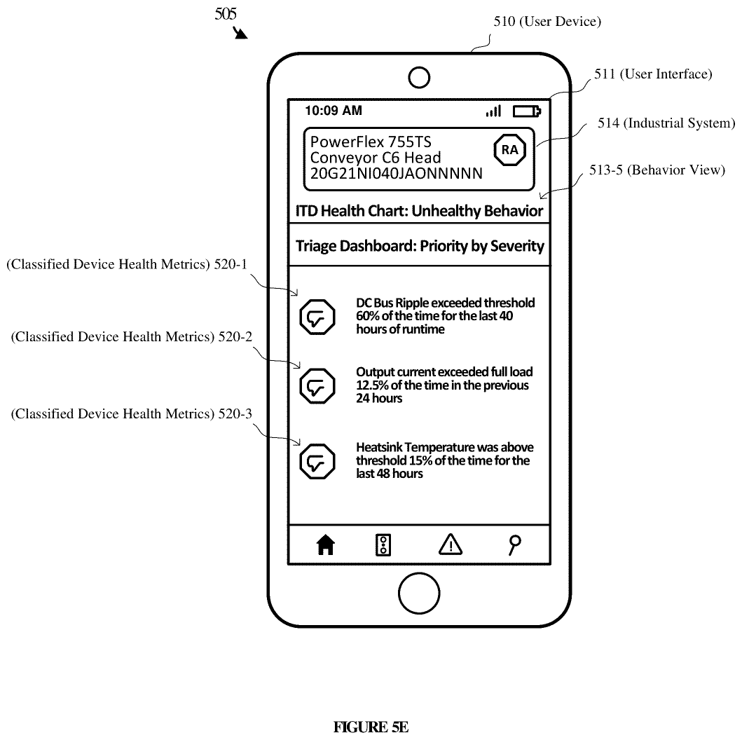

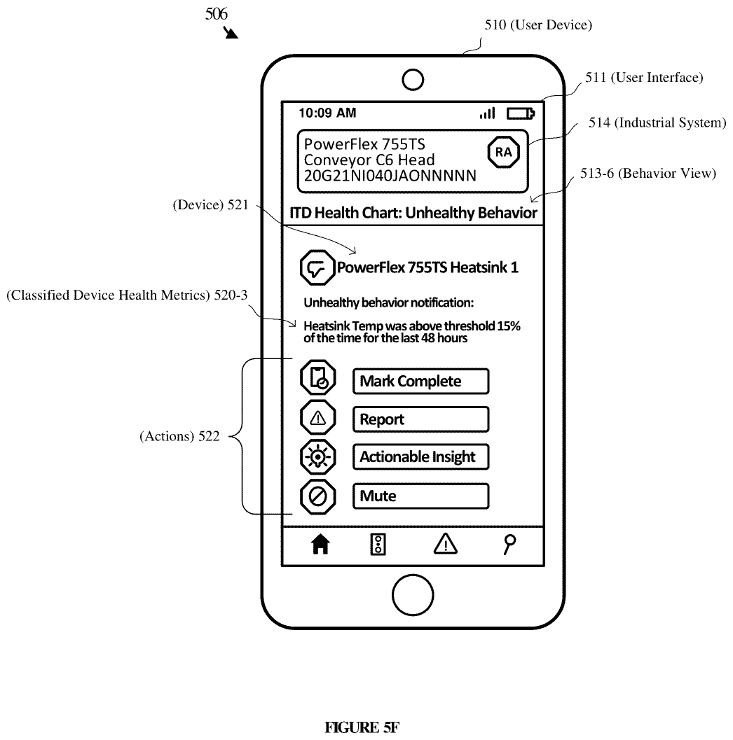

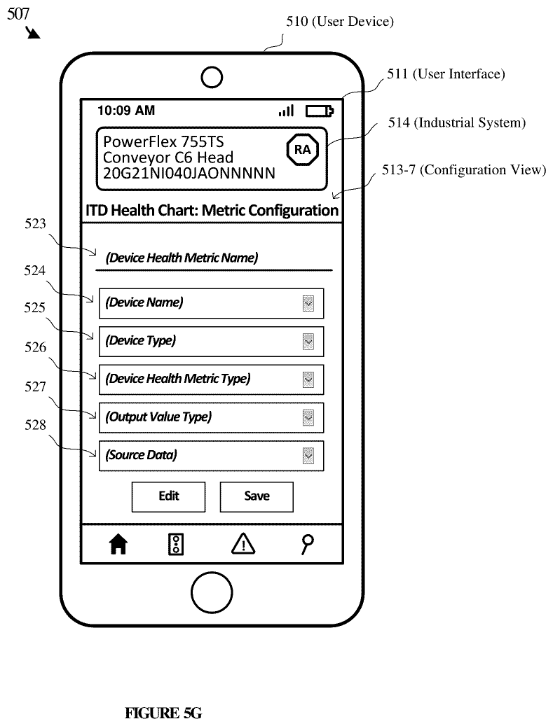

In various examples, server 115 identifies which operations to perform on the performance metrics and which contextualization information to use in the associated contextualization based on configuration settings provided by a user via a device health application running on a user device (e.g., user device 110, user device 111). For example, a user can define operations and select which operations can be applied to performance metrics. Further, the user can define the contextualization information and select which contextualization information is associated with the performance metrics. Various other ways of configuring the operations and contextualization metrics may be contemplated. An example configuration view for configuring such information is shown in FIG. 5G and discussed below. In other examples, server 115 may contextualize the performance metrics based on default configuration settings. Default configuration settings may also be pre-configured based on the type of performance metrics, for example.

In operation 415, server 115 classifies (415) each of the device health metrics into device health metrics categories based on applying a rule set to each of the device health metrics. The rule sets may include threshold values, time windows or time ranges, or other defined rules. Following the previous example using percentage of current motor speed relative to total capable motor speed, a first rule set can be applied to determine the duration that the motor has been running at the current motor speed. Additionally, a second rule set can further be applied to determine whether the motor has been running beyond a threshold value for a threshold duration. As a result of applying the rule sets, the device health metrics can be classified into device health metrics categories, such as a healthy category, an unhealthy category, and an approaching unhealthy category, among other categories. For example, if industrial devices 120 perform beyond a threshold value for a threshold duration, the device health metrics may be categorized as unhealthy.

In various examples, server 115 identifies which rule sets to apply to the device health metrics based on configuration settings provided by a user via a device health application running on a user device (e.g., user device 110, user device 111). For example, a user can define rule sets, such as threshold values, time ranges, and other values and rules, and associate the defined settings with one or more device health metrics. Further, the user can define the device health metrics categories based on ranges of values resulting from applying a rule set to a device health metric. In other examples, default configuration settings may include one or more rule sets that can be used based on a type of device health metric. Types of device health metrics may include device output metrics (e.g., current, voltage, temperature), predictive device metrics (e.g., remaining life), and preventative device metrics (e.g., actionable time remaining), among other types of metrics. Various other ways of configuring the operations and contextualization metrics may be contemplated.

In operation 420, server 115 may provide (420) the device health metrics and device health metrics categories associated with a selected device to a user interface of user device 110 or user device 111 based on a request from user device 110 or user device 111. For example, a user of user device 110 or 111 may engage with a device health application to request health-related information about one or more of industrial devices 120. The request may indicate which industrial device and which device health metrics the user desires to view in the device health application. In response to the request, server 115 may provide indications of the device health metrics and corresponding classifications of the device health metrics to the user device for instantiation in the device health application displayed on the user interface. The indications may include device health indications, behavioral indications, and maintenance indications, among other indications. The device health indications indicate the health of selected industrial devices 120 devices based on associated contextualized device health metrics. The behavioral indications indicate the behavior of the selected industrial devices 120 based on the applied rule sets to the contextualized device health metrics. The maintenance indications may indicate maintenance tasks corresponding to the selected industrial devices 120 based on the contextualized device health metrics and the behavior.

In various examples, the operations of process 400 can be repeated for any number of requests by a user of user devices 110 or 111. Additionally, the device health application displayed on user devices 110 or 111 may provide configuration capabilities to allow a user to define new device health metrics and device health metrics categories, as well as to define or make necessary adjustments to the contextualization engine 210 and classification engine 220. Accordingly, server 115 can perform the operations of process 400, or variations thereof, based on the request and desired indications to be displayed on user device 110 or user device 111.

FIGS. 5A, 5B, 5C, 5D, 5E, 5F, and 5G illustrate example representations of a user interface including device health metrics of industrial devices in accordance with some embodiments of the present technology. FIGS. 5A, 5B, 5C, 5D, 5E, 5F, and 5G each demonstrate an aspect of a user experience for configuring and viewing device health information corresponding to one or more industrial devices in an industrial automation environment on user interface 511 of user device 510. In various examples, a user can navigate between the aspects and views of user interface 511 shown in FIGS. 5A, 5B, 5C, 5D, 5E, 5F, and 5G by interacting with user interface 511 (e.g., tap, swipe, click). User device 510 may exemplify user device 111 of operating environment 100 of FIG. 1. The device health information displayed on user interface 511 of user device 510 may be provided by a server, such as server 115 of FIG. 1 or server 201 of FIG. 2.

FIG. 5A includes aspect 501, which illustrates user device 510 and a dashboard 512-1 displayed on user interface 511 of user device 510. User device 510 is representative of a handheld device, such as a smart phone or tablet, having a touchscreen that can be used to both display information on user interface 511 and provide for interaction with dashboard 512-1, device triage view 513-1 of dashboard 512-1, and other views and dashboards of a device health application displayed on user interface 511.

User interface 511 may display an instance of the device health application that may run on user device 510. The instance displayed on user interface 511 may include one or more navigable dashboards (e.g., dashboard 512-1), each having information about the industrial devices and related performance and health obtained from a server. For example, dashboard 512-1 may show industrial system 514, a device triage view 513-1, device health topics 515, and status indications 516.

Industrial system 514 may indicate which industrial device or industrial system of industrial devices user interface 511 is displaying information about. In some cases, user device 510 may be connected to one or more devices of industrial system 514 or a controller coupled to devices of industrial system 514. In this example, industrial system 514 indicates that the system is named “PowerFlex 755TS Conveyer C6 Head,” which may include various devices, components, and equipment that can perform an industrial or commercial process.

Device triage view 513-1 refers to a name of a page or view on dashboard 512-1 that can be displayed on user interface 511. In aspect 501, device triage view 513-1 may include device health topics 515 and corresponding status indications 516. Device health topics 515 include various device health or condition related topics, such as device vitals, device state, predictive maintenance, preventative maintenance, unhealthy behavior, conditioning monitoring, and computerized maintenance management software (CMMS). Conditioning monitoring may include software that receives data from smart devices and performs motor current signature analysis and inform potential problems such as motor bearings issues and pump cavitation, for example. CMMS may include software that helps manage assets, schedule maintenance, and track work orders, for example. Status indications 516 may indicate a healthy status, an unhealthy status, or an approaching unhealthy status.

In use, user device 510 can connect to a server and one or more industrial devices in an industrial automation environment via a wireless connection (e.g., Bluetooth, Wi-Fi, NFC). In some cases, user device 510 can connect directly to an industrial device. In other cases, user device 510 may connect to a controller (e.g., a PLC) coupled to the industrial device. Regardless, user device 510 can request information related to performance and health of the industrial devices from the server, the controller, or the industrial devices. The server can receive the request, obtain performance metrics from the selected industrial devices, and perform device health processes, such as processes described above in FIGS. 2-4, and provide indications of health and performance metrics for display on user interface 511.

Referring next to FIG. 5B, FIG. 5B includes aspect 502, which illustrates device vitals view 513-2 on user interface 511 of user device 510. Device vitals view 513-2 may include contextualized performance metrics of industrial system 514, or devices associated with industrial system 514, related to device health topic 515-1, device vitals. In this example, device vitals view 513-2 includes device health metrics 517-1, device health metrics 517-2, and device health metrics 517-3.

Device health metrics 517-1 includes contextualized performance metrics derived from current outputs of industrial system 514. More specifically, device health metrics 517-1 includes a motor current percentage, (95%), a drive usage percentage (82.5%), a peak motor speed percentage (101%), and a peak drive usage percentage (87%). These values may indicate whether industrial system 514, or more particularly the motor and drive of industrial system 514, are operating below, at, or above a capacity.

Device health metrics 517-2 includes contextualized performance metrics derived from voltage outputs of industrial system 514. More specifically, device health metrics 517-2 includes average DC bus voltage (677.28 V), unfiltered DC bus voltage (689.31 V), and DC bus bias ripple (4.2%). These values may indicate whether a DC bus of industrial system 514 is outputting too much, too little, or a normal voltage to other devices in industrial system 514.

Device health metrics 517-3 includes contextualized performance metrics derived from motor outputs of industrial system 514. More specifically, device health metrics 517-3 includes a motor overload value (86%) and a motor setting (10). These values may indicate whether the motor of industrial system 514 is overloaded or operating normally.

In various examples, a server can determine device health metrics 517-1, 517-2, and 517-3 by contextualizing performance metrics of industrial system 514. Performance metrics may include raw outputs or signals obtained from industrial system 514, such as output current, output voltage, and motor speed, among other signals. The server can contextualize device health metrics 517-1, 517-2, and 517-3 by using contextualization information specific to a metric of device health metrics 517-1, 517-2, and 517-3 and performing one or more operations on the metrics. Contextualization information may refer to information indicative of a type of a value (e.g., voltage, temperature, current, speed) or unit of measurement of a value (e.g., volts, degrees Fahrenheit, amps, RPM). By way of example, to determine the motor speed percentage of device health metrics 517-1, the server may perform one or more operations using the output current of a motor of industrial system 514, such as an operation to convert the output value current from amps to a percentage based on the nominal motor current. By way of another example, to determine the peak motor current percentage of device health metrics 517-1, the server may perform one or more different operations using the output current of the motor of industrial system 514. Thus, the server can perform any combination or variation of operations based on desired output metrics in device health metrics 517-1, 517-2, and 517-3 for display in device vitals view 513-2.

The server may account for device health metrics 517-1, 517-2, and 517-3, among other metrics, to determine status indication 516-1. For example, the server can apply one or more rule sets to device health metrics 517-1, 517-2, and 517-3 to determine whether any values within device health metrics 517-1, 517-2, and 517-3 exceed unhealthy threshold values. In cases where device health metrics 517-1, 517-2, and 517-3 include values that do not exceed threshold values, status indication 516-1 can indicate that device health topic 515-1 includes healthy metrics.

FIG. 5C includes aspect 503, which illustrates predictive maintenance view 513-3 on user interface 511 of user device 510. Predictive maintenance view 513-3 may include contextualized performance metrics and status indications related to predicted life or use remaining of industrial devices in industrial system 514. In this example, predictive maintenance view 513-3 includes predicted metrics 518-1 and predicted metrics 518-2.

Predicted metrics 518-1 includes contextualized and classified metrics derived from outputs of industrial system 514. More specifically, predicted metrics 518-1 indicates a predicted remaining life of a heatsink fan of industrial system 514 (45%) and a status indication corresponding to the predicted remaining life. Predicted metrics 518-2 also includes contextualized and classified performance metrics derived from outputs of industrial system 514. Predicted metrics 518-2 indicates a predicted remaining life of a stirring fan of industrial system 514 (20%) and a status indication corresponding to the predicted remaining life.

To determine predicted metrics 518-1 and 518-2, a server may first contextualize performance metrics related to performance of the heatsink fan and the stirring fan of industrial system 514, respectively. The server can then apply one or more rule sets to the contextualized performance metrics to classify the data into a category corresponding to predicted remaining life. The rule sets may include threshold values, time ranges, and historical data. By way of example, the server can use the rule sets to determine the duration of operation of the fans, how the fans are operating compared to threshold values, and the like, to categorize the fans as healthy, unhealthy, or approaching unhealthy. The server can also identify percentage values to quantify the remaining life in determining predicted metrics 518-1 and 518-2.

Next, FIG. 5D includes aspect 504, which illustrates preventative maintenance view 513-4 on user interface 511 of user device 510. Preventative maintenance view 513-4 may include contextualized performance metrics and status indications related to tasks and a time frame for performing tasks to prevent risk to industrial devices in industrial system 514. In this example, preventative maintenance view 513-4 includes preventative metrics 519-1, preventative metrics 519-2, and preventative metrics 519-3.

Preventative metrics 519-1 includes contextualized and classified metrics derived from outputs of industrial system 514. More specifically, preventative metrics 519-1 can indicate a predicted date or time to take an action to prevent risk to a motor of industrial system 514, such as lubricating the motor in 43 days. Preventative metrics 519-2 also includes contextualized and classified performance metrics derived from outputs of industrial system 514. Preventative metrics 519-2 indicates that a machine in industrial system 514 may need to be lubricated in 103 days. Likewise, preventative metrics 519-3 includes contextualized and classified performance metrics derived from outputs of industrial system 514. Preventative metrics 519-3 indicates that machine bearings in industrial system 514 may need to be replaced in 14 days.

Preventative maintenance view 513-4 can also include a status indication corresponding to the upcoming tasks in preventative metrics 519-1, 519-2, and 519-3. In some cases, a healthy status indication may include a high percentage value indicating a remaining life of the device in industrial system 514. It follows that machine bearings, which preventative metrics 519-3 indicates have 14 days until a preventative maintenance action can occur, may have a corresponding unhealthy status indication as the machine bearings only have 5% remaining life.

To determine preventative metrics 519-1, 519-2, and 519-3, a server may first contextualize performance metrics related to performance of the motor, machine, and machine bearings of industrial system 514, respectively. The server can then apply one or more rule sets to the contextualized performance metrics to classify the data into a category corresponding to predicted remaining life and time to repair or replacement. The rule sets may include threshold values, time ranges, and historical data. By way of example, the server can use the rule sets to determine the duration of operation of the motor, the machine, and the machine bearings and the last repair or replacement action taken on each of the components. The server can also identify percentage values to quantify the remaining life before repair or replacement in determining preventative metrics 519-1, 519-2, and 519-3.

FIG. 5E includes aspect 505, which illustrates behavior view 513-5 on user interface 511 of user device 510. Behavior view 513-5 may include device health metrics categories, notifications related to device health metrics and the device health metrics categories, and corresponding status indications sorted by severity, from most severe to least severe. Behavior view 513-5 includes classified device health metrics 520-1, classified device health metrics 520-2, and classified device health metrics 520-3.

Classified device health metrics 520-1 includes information related to the health and behavior of a DC bus of industrial system 514. More specifically, classified device health metrics 520-1 can indicate that the DC bus ripple has exceeded a threshold bias ripple 60% of the time for the last 40 hours of run-time.

Classified device health metrics 520-2 includes information related to the health and behavior of a motor of industrial system 514. More specifically, classified device health metrics 520-2 can indicate that the motor output current has exceeded a threshold motor current for 12.5% of the time in the last 24 hours of run-time.

Classified device health metrics 520-3 includes information related to the health and behavior of a heatsink fan of industrial system 514. More specifically, classified device health metrics 520-3 can indicate that the heatsink fan temperature exceeded a threshold temperature for 15% of the time for the last 48 hours.

To determine classified device health metrics 520-1, 520-2, and 520-3, a server may first contextualize performance metrics related to performance of the DC bus, motor, and heatsink fan of industrial system 514, respectively. The server can then apply one or more rule sets to the contextualized performance metrics to classify the data into a category corresponding performance in comparison to unhealthy performance. The rule sets may include threshold values, time ranges, and historical data, among other rules. By way of example, with respect to classified device health metrics 520-1, the server can use a rule set including a threshold bias ripple and a rule set including a time range (e.g., 40 hours) to compare DC bus performance metrics, contextualized into a percentage value, to the threshold bias ripple and determine for what percentage the DC bus operated over the threshold bias ripple during the time range. By way of another example, with respect to classified device health metrics 520-2, the server can use a rule set including a threshold motor current and a rule set including a time range (e.g., 24 hours) to compare motor output current, contextualized into a percentage value, to the threshold motor current and determine for what percentage the motor output current exceeded the threshold motor current during the time range. By way of yet another example, with respect to classified device health metrics 520-3, the server can use a rule set including a threshold temperature and a rule set including a time range (e.g., 48 hours) to compare heatsink fan temperature, contextualized into a percentage value, to the threshold temperature and determine for what percentage the heatsink fan temperature exceeded the threshold temperature during the time range.

Various rule sets can be defined and re-configured based on the needs of a user of user device 510. Therefore, behavior view 513-5 may display different classified device health metrics for any number of devices of industrial system 514. Additionally, behavior view 513-5 may be sorted or filtered in various ways, such as alphabetical order, sequential order with respect to an industrial process, and the like.

FIG. 5F includes aspect 506, which illustrates behavior view 513-6 on user interface 511 of user device 510. Behavior view 513-6 may include device health metrics categories, notifications related to device health metrics and the device health metrics categories and steps a user can take based on the device health metrics and the device health metrics categories. More specifically, behavior view 513-6 includes device 521, classified device health metrics 520-3, and actions 522.

Referring back to aspect 505 of FIG. 5E, a user may see that a heatsink fan has been operating at a temperature over a threshold temperature for 48 hours according to classified device health metrics 520-3. In various examples, a user can click or tap on the notification in behavior view 513-5 shown on user interface 511 to navigate to behavior view 513-6 and see more information about the heatsink. Accordingly, referring now to aspect 506, a user can see that the heatsink fan, device 521, is named “PowerFlex 755TS Heatsink 1.”

Behavior view 513-6 also includes classified device health metrics 520-3. Classified device health metrics 520-3 includes information related to the health and behavior of device 521 of industrial system 514. More specifically, classified device health metrics 520-3 can indicate that the temperature of Heatsink 1 has exceeded a threshold temperature by 15% of the time for the last 48 hours.

Additionally, behavior view 513-6 includes actions 522 corresponding to device 521 and classified device health metrics 520-3. Actions 522 may include a “mark complete” action, a “report” action, “an actionable insight” action, and a “mute” action. Actions 522 may allow a user to take steps to resolve, report, or ignore classified device health metrics 520-3. For example, a user may have physically fixed the temperature issue with device 521, so a user can use “mark complete” of actions 522 to dismiss the notification. Alternatively, a user may escalate the issue to a supervisor, for example, by using the “report” action of actions 522. Various other actions can be displayed and interacted with on user interface 511 to allow a user to prevent risk to industrial system 514. In various examples, actions 522 can be configured and defined by a user of user device 510, such as in a configuration view, which will be described next in FIG. 5G.

FIG. 5G includes aspect 507, which illustrates configuration view 513-7 on user interface 511 of user device 510. Configuration view 513-7 may include text boxes, drop-down menus, checkboxes, selection windows, and the like that a user can interact with to configure device health metrics and device health metrics categories for use in device health processes also described and illustrated in aspects 501-506. For example, configuration view 513-7 includes device health metric name 523, device name 524, device type 525, device health metric type 526, output value type 527, and source data 528.

Device health metric name 523 corresponds to a name for a device health metric. For example, referring to aspect 502 of FIG. 5B, device health metric name 523 corresponding to device health metrics 517-1 may be “motor current percentage.” In various examples, device health metric name 523 may include a text box that a user can type letters or other characters into via a keyboard on user interface 511 of user device 510.

Device name 524 corresponds to the name of an industrial device of industrial system 514. For example, referring to aspect 506 of FIG. 5F, device name 524 corresponding to classified device health metrics 520-3 may be “PowerFlex 755TS Heatsink 1.” In various examples, a user may choose device name 524 from a drop-down list populated with devices of industrial system 514. In other examples, device name 524 may include a text box.

Device type 525 corresponds to a type of an industrial device of industrial system 514. Following the previous example involving device name 524 corresponding to “PowerFlex 755TS Heatsink 1” of aspect 506, device type 525 may be “heatsink fan” as illustrated in aspect 503 of FIG. 5C under predicted metrics 518-1. In various examples, a user may choose device type 525 from a drop-down list with selections corresponding to the industrial devices of industrial system 514.

Device health metric type 526 corresponds to a type of device health metric desired to be output by a server performing operations and contextualization on the performance metrics of the industrial devices of industrial system 514. For example, device health metric type 526 may include a value, a notification, a status indication, a remaining capacity or lifespan, and more. More specifically, a user may desire contextualization of an output value of an industrial device. In another example, a user may desire a status indication (e.g., healthy, unhealthy, approaching unhealthy) based on contextualization of an output value of an industrial device. Accordingly, the user can select a desired choice from a drop-down list of device health metric type 526.

Output value type 527 corresponds to a unit of measurement for the device health metric. For example, referring again to aspect 502 of FIG. 5B, output value type 527 of device health metrics 517-1 may be a percentage value. Output value type 527 of device health metrics 517-2 may be a voltage value. Other examples of output value type 527 may include amps, RPM, units of time, temperature, and more. In various examples, a user may choose output value type 527 from a pre-configured list of selections. In other examples, however, a user may input a selection in a textbox.

Source data 528 corresponds to a source for raw data to be used in the contextualization and classification of the device health metric. For example, referring again to aspect 502 of FIG. 5B, source data 528 of device health metrics 517-1 may be a motor of industrial system 514. More particularly, source data 528 may include the current or motor speed of the motor. Source data 528 of device health metrics 517-2 may be a DC bus of industrial system 514. Other examples of source data 528 include sensors, gears, belts, drives, or any other device of industrial system 514 that produces a signal indicative of performance of the device. A user may select source data 528 from a drop-down list based on industrial system 514.

Various other selections and modifications may be included in configuration view 513-7. The selections shown may be pre-configured or may be selected in another configuration view (not shown). Further, the items in drop-down lists, checkboxes, or the like may be pre-configured, automatically populated based on industrial system 514, or edited during run-time in another configuration view. Accordingly, any combination or variation of configuration parameters and selections may be contemplated to build a user experience for a user of user device 510 in performing device health processes. As selections are saved in configuration view 513-7 and requests for data are made by a user, device health metrics and device health metrics categories and classifications may be surfaced on user interface 511 as illustrated in the various views of aspects 501-506.

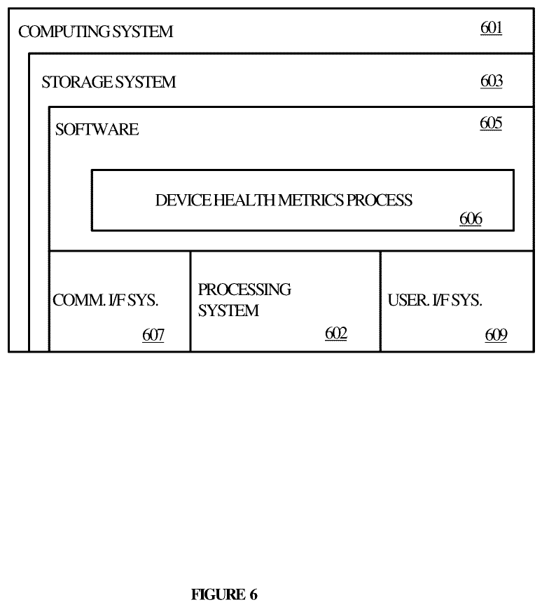

FIG. 6 illustrates computing system 601 to perform device health metric contextualization and classification, according to an implementation of the present technology. Computing system 601 is representative of any system or collection of systems with which the various operational architectures, processes, scenarios, and sequences disclosed herein for device health collection and configuration may be employed. Computing system 601 may be implemented as a single apparatus, system, or device or may be implemented in a distributed manner as multiple apparatuses, systems, or devices. Computing system 601 includes, but is not limited to, processing system 602, storage system 603, software 605, communication interface system 607, and user interface system 609 (optional). Processing system 602 is operatively coupled with storage system 603, communication interface system 607, and user interface system 609. Computing system 601 may be representative of a cloud computing device, distributed computing device, or the like.

Processing system 602 loads and executes software 605 from storage system 603. Software 605 includes and implements device health metrics process 606, which is representative of any of the performance metrics gathering, contextualization, categorization, and classification processes discussed with respect to the preceding Figures. When executed by processing system 602 to provide device health metrics functions, software 605 directs processing system 602 to operate as described herein for at least the various processes, operational scenarios, and sequences discussed in the foregoing implementations. Computing system 601 may optionally include additional devices, features, or functionality not discussed for purposes of brevity.

Referring still to FIG. 6, processing system 602 may comprise a micro-processor and other circuitry that retrieves and executes software 605 from storage system 603. Processing system 602 may be implemented within a single processing device but may also be distributed across multiple processing devices or sub-systems that cooperate in executing program instructions. Examples of processing system 602 include general purpose central processing units, graphical processing units, application specific processors, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device but may also be implemented across multiple storage devices or sub-systems co-located or distributed relative to each other. Storage system 603 may comprise additional elements, such as a controller capable of communicating with processing system 602 or possibly other systems.

Software 605 (including device health metrics process 606) may be implemented in program instructions and among other functions may, when executed by processing system 602, direct processing system 602 to operate as described with respect to the various operational scenarios, sequences, and processes illustrated herein. For example, software 605 may include program instructions for implementing a device health metrics process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtualization software, or other application software. Software 605 may also comprise firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system customized to provide device health metrics and contextualization and instantiation thereof as described herein. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise.” “comprising.” and the like are to be construed in an inclusive sense, as opposed to an exclusive or exhaustive sense; that is to say, in the sense of “including, but not limited to.” As used herein, the terms “connected.” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or.” in reference to a list of two or more items, covers all of the following interpretations of the word: any of the items in the list, all of the items in the list, and any combination of the items in the list.

While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112 (f) will begin with the words “means for” but use of the term “for” in any other context is not intended to invoke treatment under 35 U.S.C. § 112 (f). Accordingly, the applicant reserves the right to pursue additional claims after filing this application to pursue such additional claim forms, in either this application or in a continuing application.

What is claimed is:

1. A system, comprising:
one or more computer-readable storage media;
one or more processors coupled to the one or more computer-readable storage media; and
program instructions stored on the one or more computer-readable storage media that, based on being read and executed by the one or more processors, direct the system to:
obtain a plurality of performance metrics, each performance metric associated with a device in an industrial automation environment;
contextualize each of the performance metrics based on contextualization information specific to each of the performance metrics to produce device health metrics, each device health metric corresponding to a performance metric of the performance metrics;
classify each of the device health metrics into device health metric categories based on applying a rule set to each of the device health metrics, wherein the rule set is selectively applied to a respective device health metric based on a type of the respective device health metric; and
provide, based on a request from a user device, a device health metric and a device health metric category associated with a selected device to a user interface of the user device.

2. The system of claim 1, wherein to contextualize each of the performance metrics, the program instructions direct the system to perform one or more operations on each of the performance metrics.

3. The system of claim 1, wherein the rule set comprises one or more of threshold data, a time range, and a quantity.

4. The system of claim 3, wherein the rule set is user-selected via the user interface of the user device.

5. The system of claim 1, wherein the device is a variable-speed drive.

6. The system of claim 5, wherein the device health metrics indicate health of one or more industrial devices coupled to the variable-speed drive.

7. The system of claim 1, wherein the device health metric categories comprise a healthy category, an unhealthy category, and an approaching unhealthy category.

8. A method, comprising:
obtaining a performance metric associated with a device in an industrial automation environment;
contextualizing the performance metric based on contextualization information specific to the performance metric to produce a device health metric corresponding to the performance metric of the device;
classifying the device health metric into a device health metric category based on applying a rule set to the device health metric, wherein the rule set is selectively applied to the device health metric based on a type of the device health metric; and
providing, based on a request from a user device, the device health metric and the device health metric category to a user interface of the user device.

9. The method of claim 8, wherein the performance metric is a first performance metric of a plurality of performance metrics, wherein the device is a first device of a plurality of devices in the industrial automation environment, and wherein each performance metric of the plurality of the performance metrics is associated with a device of the plurality of the devices.

10. The method of claim 8, wherein contextualizing the performance metric comprises performing one or more operations on the performance metric using the contextualization information.

11. The method of claim 10, wherein the contextualization information comprises signals indicative of one or more of an electrical value, a mechanical value, and a thermal value associated with the device.

12. The method of claim 8, wherein the rule set comprises one or more of threshold data, a time range, and a quantity.

13. The method of claim 12, wherein the rule set is user-selected via the user interface of the user device.

14. The method of claim 8, wherein the device is a variable-speed drive.

15. The method of claim 14, wherein the device health metric indicates health of one or more industrial devices coupled to the variable-speed drive.

16. The method of claim 8, wherein the device health metric category comprises one of a healthy category, an unhealthy category, and an approaching unhealthy category.

17. A system, comprising:
one or more computer-readable storage media;
one or more processors coupled to the one or more computer-readable storage media; and
program instructions stored on the one or more computer-readable storage media that, based on being read and executed by the one or more processors, provide a user interface to a user device, wherein the user interface comprises:
a dashboard navigable by a user of the user device; and
indications corresponding to one or more devices of an industrial automation environment, wherein the indications comprise:
device health indications indicative of a health of the one or more devices based on contextualized metrics determined by performing operations on performance metrics associated with the one or more devices;
behavioral indications indicative of a behavior of the one or more devices based on applying rule sets to the contextualized metrics; and
maintenance indications indicative of maintenance tasks corresponding to the one or more devices based on the behavior indications and the device health indications.

18. The system of claim 17, further comprising a health metrics server configured to:
obtain the performance metrics associated with the one or more devices;
contextualize each of the performance metrics based on contextualization information specific to each of the performance metrics to produce the contextualized metrics, each contextualized metric corresponding to a performance metric of the performance metrics; and
classifying each of the contextualized metrics into behaviors based on applying a rule set to each of the contextualized metrics, wherein the rule set is selectively applied to a respective contextualized metric based on a type of the respective contextualized metric.

19. The system of claim 18, wherein the behaviors comprise a healthy behavior, an unhealthy behavior, and an approaching unhealthy behavior.

20. The system of claim 17, wherein the one or more devices are coupled to a variable-speed drive.
